(19) United States
(12) Patent Application Publication
(10) Pub. No.: US 2006/0288539 A1
(43) Pub. Date: Dec. 28, 2006

(54) DISPLACEMENT LOCK MLT

(75) Inventors: Jack E Caveney, Hinsdale, IL (US); John J. Bulanda, New Lenox, IL (US); Scott R. Hartman, Oak Forest, IL (US)

Correspondence Address: PANDUIT CORP., LEGAL DEPARTMENT - TP12, 17301 SOUTH RIDGELAND AVENUE, TINLEY PARK, IL, 60477, US

(73) Assignee: PANDUIT CORP., Tinley Park, IL (US)

(21) Appl. No.: 11/420,370

(22) Filed: May 25, 2006

Related U.S. Application Data
(60) Provisional application No. 60/684,913, filed on May 26, 2005.

(51) Int. Cl. F16L 33/00

(52) U.S. Cl. 24/20 R

(57) ABSTRACT

A metal locking tie formed from a locking head and an elongate strap extending through the locking head. The locking head is defined by a top wall a bottom wall and two sides. The locking head includes a slot that extends through the locking head from an entrance end to an exit end. The bottom wall of the locking head has a tab that extends upwardly toward the slot in the locking head. The strap has a first end, a second end, and an aperture therethrough. When the strap is positioned within the locking head the upwardly extending tab of the locking head engages the aperture in the strap. A metal locking tie tool secures the strap to the locking head by displacing a portion of the strap in the locking head.

### CROSS REFERENCE TO RELATED APPLICATION

This application claims priority to U.S. Provisional Application No. 60/684,913 filed May 26, 2005, the entire contents of which are hereby incorporated by reference.

### FIELD OF THE INVENTION

The present invention relates to metal locking ties, and more particularly to metal locking ties with a locking mechanism that displaces the strap within the locking head to lock the strap in the locking head.

### BACKGROUND OF THE INVENTION

Metallic bundling devices incorporating locking balls and roller pins have been used for bundling bales of cotton or the like since the Nineteenth Century. None of the prior devices were positive locking, i.e. depending on the orientation of the locking head, gravity could hold the ball out of locking engagement with the strap resulting in release of the tightened strap. U.S. Pat. No. 4,399,592 addressed this problem by teaching the addition of a raised portion or protuberance for deflecting the threaded strap away from the floor as the threaded strap exits the locking head. This deflection ensures that the locking ball is in continuous engagement with the threaded strap regardless of the position of the ball or the orientation of the locking head.

It would also be desirable to provide a metal locking tie having a locking mechanism that does not require locking balls or roller pins to secure the strap within the locking head.

### SUMMARY OF THE INVENTION

The present invention is directed toward a metal locking tie having a locking head and an elongate strap. The locking head is defined by a top wall, a bottom wall and two sides. The locking head includes a slot that extends through the locking head from an entrance end to an exit end. The bottom wall of the locking head has an aperture and a tab that extends upwardly toward the slot in the locking head. The strap has a first end, a second end, and an aperture therethrough. The strap is positioned within the locking head such that the upwardly extending tab of the locking head engages the aperture in the strap. The strap wraps around the objects to be bundled and reenters the locking head. Next, the assembled locking tie is positioned in a metal locking tie tool that tensions the strap and displaces a portion of the strap in the locking head to secure the strap in the locking head. After the strap is secure, the metal locking tie tool cuts the strap flush with the locking head.

### BRIEF DESCRIPTION OF THE DRAWINGS

FIG. 1 is a sectional view of a first embodiment of a metal locking tie of the present invention with a cutting device engaging the strap;

FIG. 2 is a sectional view of the metal locking tie of FIG. 1 with the cutting device activated to cut the strap and the locking punch activated to displace the strap;

FIG. 3 is a top perspective view of the metal locking tie of FIG. 2 where the strap is secured to the head;

FIG. 4 is a bottom perspective view of the metal locking tie of FIG. 3;

FIG. 5 is a sectional view of a second embodiment of the metal locking tie of the present invention;

FIG. 6 is a sectional view of the metal locking tie of FIG. 5 with a cutting device engaging the strap;

FIG. 7 is a sectional view of the metal locking tie of FIG. 5 supported in the locking tie tool before the tool is activated;

FIG. 8 is a sectional view of the metal locking tie of FIG. 7 supported in the locking tie tool after the tool has been activated;

FIG. 9 is a sectional view of the metal locking tie of FIG. 5 with the cutting device activated to cut the strap and the locking punch activated to displace the strap;

FIG. 10 is a top perspective view of the metal locking tie of FIG. 5 where the strap is secured to the head;

FIG. 11 is a bottom perspective view of the metal locking tie of FIG. 10;

FIG. 12 is a sectional view of an alternative design of the second embodiment of the metal locking tie illustrated in FIG. 5 with the cutting device activated to cut the strap and the locking punch activated to displace the strap;

FIG. 13 is a sectional view of the metal locking tie of FIG. 12 supported in the locking tie tool after the tool has been activated;

FIG. 14 is a top perspective view of the metal locking tie of FIG. 12 where the strap is secured to the head;

FIG. 15 is a bottom perspective view of the metal locking tie of FIG. 14;

FIG. 16 is a sectional view of a third embodiment of the metal locking tie of the present invention;

FIG. 17 is a sectional view of the metal locking tie of FIG. 16 with a cutting device engaging the strap;

FIG. 18 is a sectional view of the metal locking tie of FIG. 16 supported in the locking tie tool before the tool is activated;

FIG. 19 is a sectional view of the metal locking tie of FIG. 16 supported in the locking tie tool after the tool has been activated;

FIG. 20 is a sectional view of the metal locking tie of FIG. 16 with the cutting device activated to cut the strap and the locking punch activated to displace the strap;

FIG. 21 is a top perspective view of the metal locking tie of FIG. 16 where the strap is secured to the head;

FIG. 22 is a bottom perspective view of the metal locking tie of FIG. 21;

FIG. 23 is sectional view of an alternative design of the third embodiment of the metal locking tie illustrated in FIG. 16 with the cutting device activated to cut the strap and the locking punch activated to displace the strap;

FIG. 24 is a sectional view of the metal locking tie of FIG. 23 supported in the locking tie tool after the tool has been activated;

FIG. 25 is a top perspective view of the metal locking tie of FIG. 23 where the strap is secured to the head;

FIG. 26 is a bottom perspective view of the metal locking tie of FIG. 25;

FIG. 27 is a sectional view of the metal locking tie with a portion of the strap curved upwards as the strap is being installed in the locking head;

FIG. 28 is a sectional view of the metal locking tie of FIG. 27 with the cutting device engaging the strap;

FIG. 29 is a sectional view of the metal locking tie of FIG. 27 supported in the locking tie tool before the tool is activated;

FIG. 30 is a sectional view of the metal locking tie of FIG. 29 supported in the locking tie tool after the tool has been activated;

FIG. 31 is a sectional view of the metal locking tie of FIG. 27 with the cutting device activated to cut the strap and the locking punch activated to displace the strap;

FIG. 32 is a sectional view of the metal locking tie of the present invention with the locking head having a fold over tab;

FIG. 33 is a sectional view of the metal locking tie of FIG. 32 with a cutting device engaging the strap;

FIG. 34 is a sectional view of the metal locking tie of FIG. 32 supported in the locking tie tool before the tool has been activated;

FIG. 35 is a sectional view of the metal locking tie of FIG. 34 supported in the locking tool after the tool has been activated;

FIG. 36 is a sectional view of the metal locking tie of FIG. 32 with the cutting device activated to cut the strap and the locking punch activated to displace the strap;

FIG. 37 is a sectional view of the metal locking tie of FIGS. 12-15 supported in an alternative metal locking tie tool having a locking punch with shoulders:

FIG. 38 is a sectional view of the metal locking tie of FIG. 37 with the cutting device activated to cut the strap and the locking punch activated to displace the strap;

FIG. 39 is a sectional view of the metal locking tie of FIGS. 23-26 supported in an alternative metal locking tie tool having a locking punch with shoulders; and

FIG. 40 is a sectional view of the metal locking tie of FIG. 39 with the cutting device activated to cut the strap and the locking punch activated to displace the strap.

### DETAILED DESCRIPTION

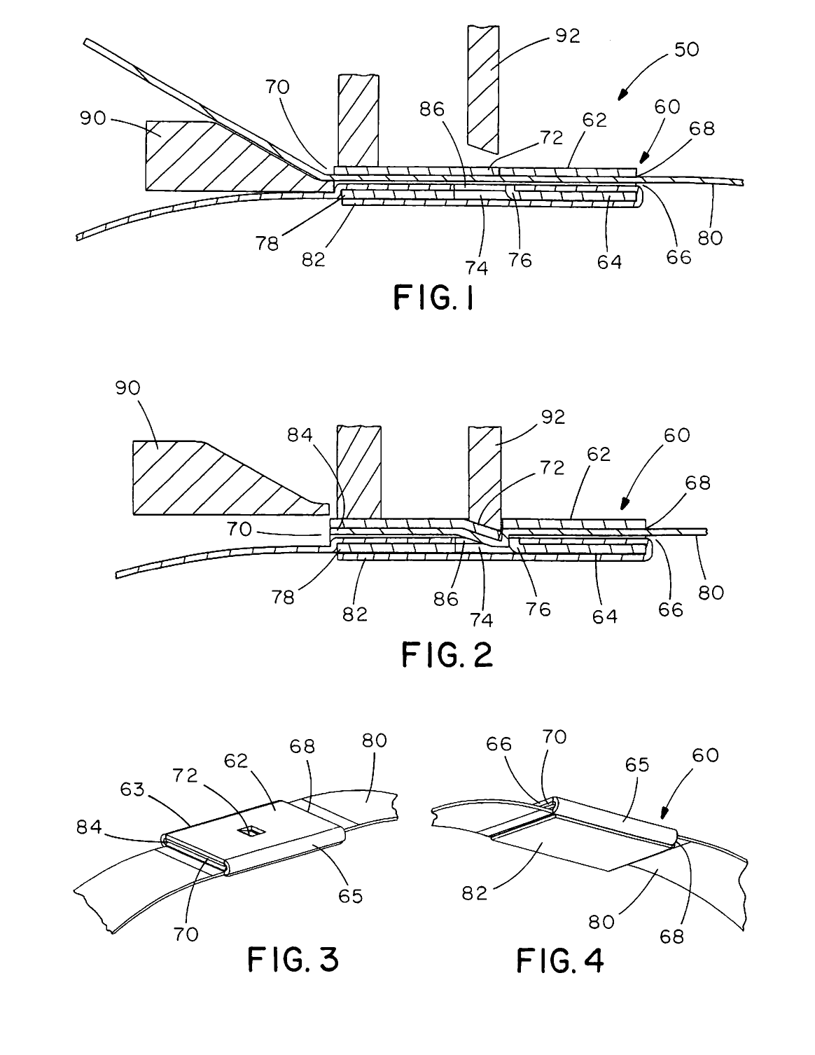

The first embodiment of the metal locking tie of the present invention is illustrated in FIGS. 1-4. The metal locking tie 50 includes a metallic locking head 60 and an elongate metallic strap 80 with a first end 82 and a second end 84. The head 60 includes a top wall 62, a bottom wall 64, sides 63, 65 and a slot 66 with an entrance end 68 and an exit end 70. The top wall 62 of the head 60 includes a top tab 72 positioned at the center of the head. As will be discussed below, the top tab 72 bends downward towards the slot 66 in the head 60 when a locking punch 92 engages the top tab 72. The bottom wall 64 of the head 60 includes an aperture 74 positioned at the center of the head 60. The bottom wall 64 also includes a bottom tab 76 positioned adjacent to the aperture 74. The bottom tab 76 extends upwards towards the slot 66.

As illustrated in FIGS. 1 and 2, the first end 82 of the strap 80 is positioned along the bottom wall 64 of the head 60. The strap 80 wraps around the head, through the entrance end 68 of the slot 66 and extends through the slot 66. The strap 80 also includes an aperture 86. The aperture 86 in the strap 80 is aligned with the top tab 72 and the aperture 74 in the bottom wall 64 of the head 60 when the strap 80 is positioned within the slot 66. The bottom tab 76 engages the aperture 86 in the strap 80 when the strap 80 extends through the slot 66.

Once the strap 80 has been wrapped around the objects to be held, the second end 84 of the strap 80 is inserted in the entrance end 68 of the slot 66 and through the slot 66. The metal locking tie tool (not shown) tensions the strap 80 and the tool is activated to secure the strap 80 to the head 60 and to cut the strap 80 (see FIG. 2).

To lock the strap 80 in the locking head 60, the locking punch 92 engages the top tab 72 in the head 60. The locking punch 92 presses the top tab 72 downwards to displace the strap 80 downward through the aperture 86 in the strap 80 into the aperture 74 in the bottom wall 64 of the head 60. As shown in FIG. 2, the displaced strap is positioned in an area behind the bottom tab 76.

Also illustrated in FIGS. 1 and 2, an edge 78 of the bottom wall 64 of the head 60 is slightly offset from the top wall of the head. The offset edge 78 provides clearance for a cutoff blade 90 of a metal locking tie tool thereby allowing the cutoff blade 90 to cut the strap 80 flush with the top wall 62 of the head 60, as shown in FIG. 2. Thus, as illustrated in FIGS. 3 and 4, the strap 80 has been cut and the second end 84 of the strap 80 is secured to the head 60.

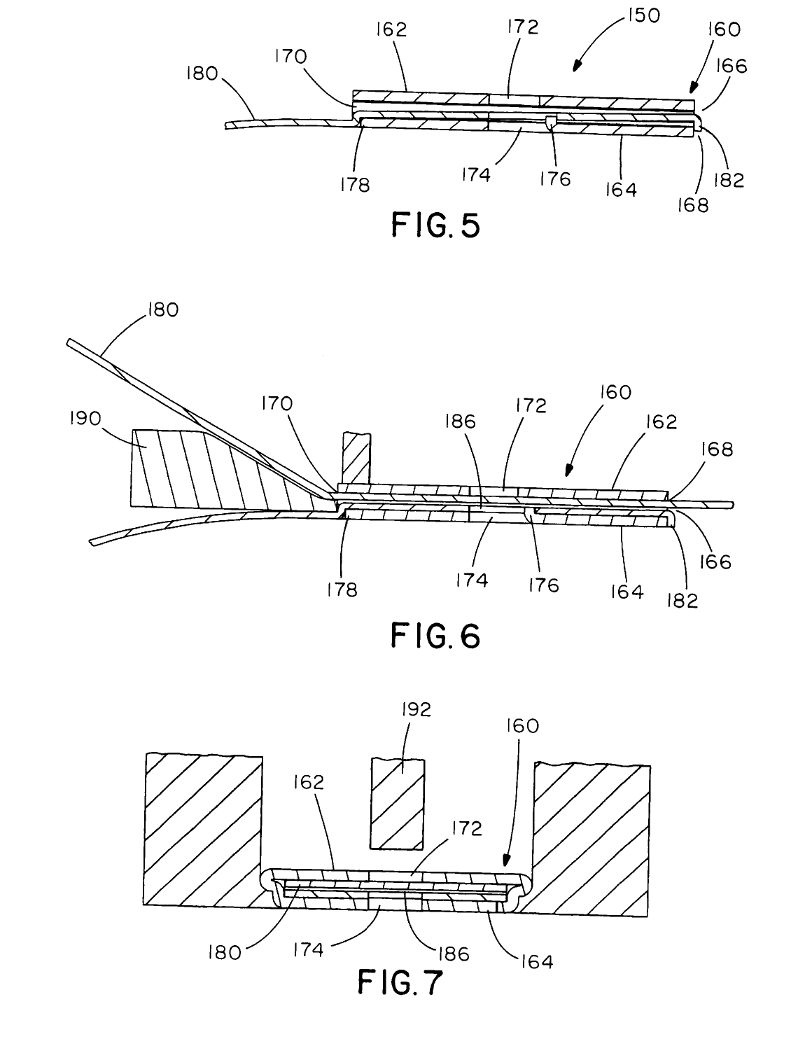

The second embodiment of the metal locking tie of the present invention is illustrated in FIGS. 5-15. As shown in FIGS. 5 and 6, the second embodiment of the metal locking tie 150 is similar to the metal locking tie 50 of the first embodiment except the locking head 160 includes a center aperture 172 in the top wall 162 instead of a top tab 72. As shown in FIGS. 5-6, the center aperture 172 in the top wall 162 is aligned with the aperture 174 in the bottom wall 164 of the head 160.

As shown in FIGS. 5-11, the first end 182 of the strap 180 engages the entrance end 168 of the slot 166 in the head 160. The first end 182 of the strap 180 is bent up to create a friction resistance with the second end 184 of the strap 180 when the second end 184 enters the slot 166 in the head. Alternatively, as illustrated in FIGS. 12-15, the first end 182 of the strap 180 may be positioned along the bottom wall 164 of the head 160 such that the strap 180 wraps around the entrance end 168 of the slot 166 and extends through the slot 166.

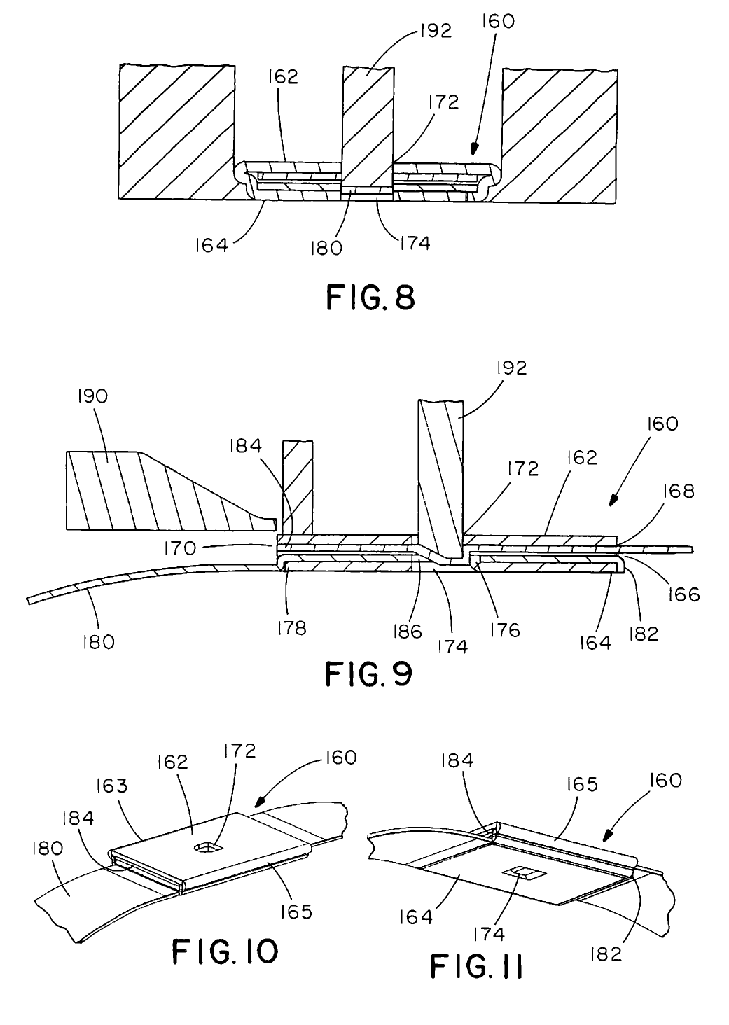

Once the strap 180 has been wrapped around the objects to be held or bundled, the second end 184 of the strap 180 is inserted in the entrance end 168 of the slot 166 and through the slot 166. The metal locking tie tool tensions the strap 180 and the tool is activated (see FIGS. 8-9 and 12-13) to secure the strap 180 to the head 160 and to cut the strap 180.

As illustrated in FIGS. 8-9 and 12-13, a locking punch 192 passes through the center aperture 172 in the top wall 162 of the head 160 to engage the strap 180. The locking punch 192 presses the strap 180 to displace a portion of the strap 180 downwards through the aperture 186 in the strap into the aperture 174 in the bottom wall 164 of the head 160. The displaced strap is positioned in an area behind the bottom tab 176 of the head 160.

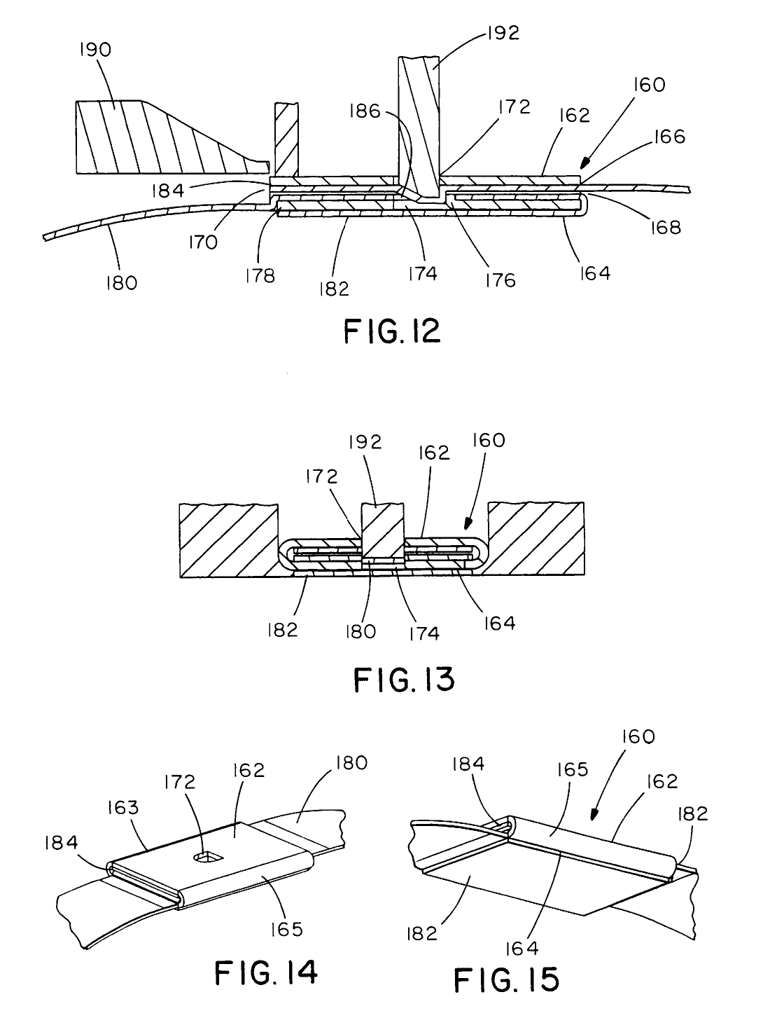

As with the metal locking tie 50 of the first embodiment illustrated in FIGS. 1 and 2, an edge 178 of the bottom wall 164 of the head 160 of the second embodiment is slightly offset from the top wall 162 of the head 160 to allow the cutoff blade 190 to cut the strap 180 flush with the top wall 162 of the head 160. Thus, as illustrated in FIGS. 10-11 and 14-15, the strap 180 has been cut and the second end 184 of the strap 180 is secured to the head 160.

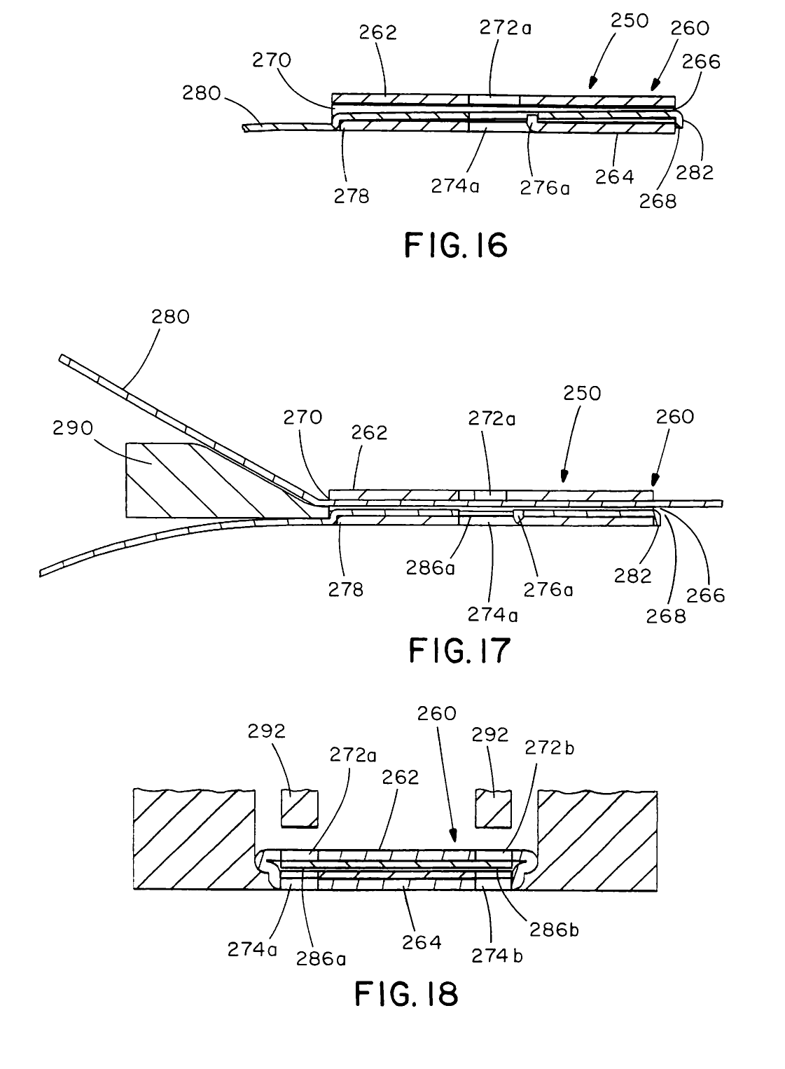

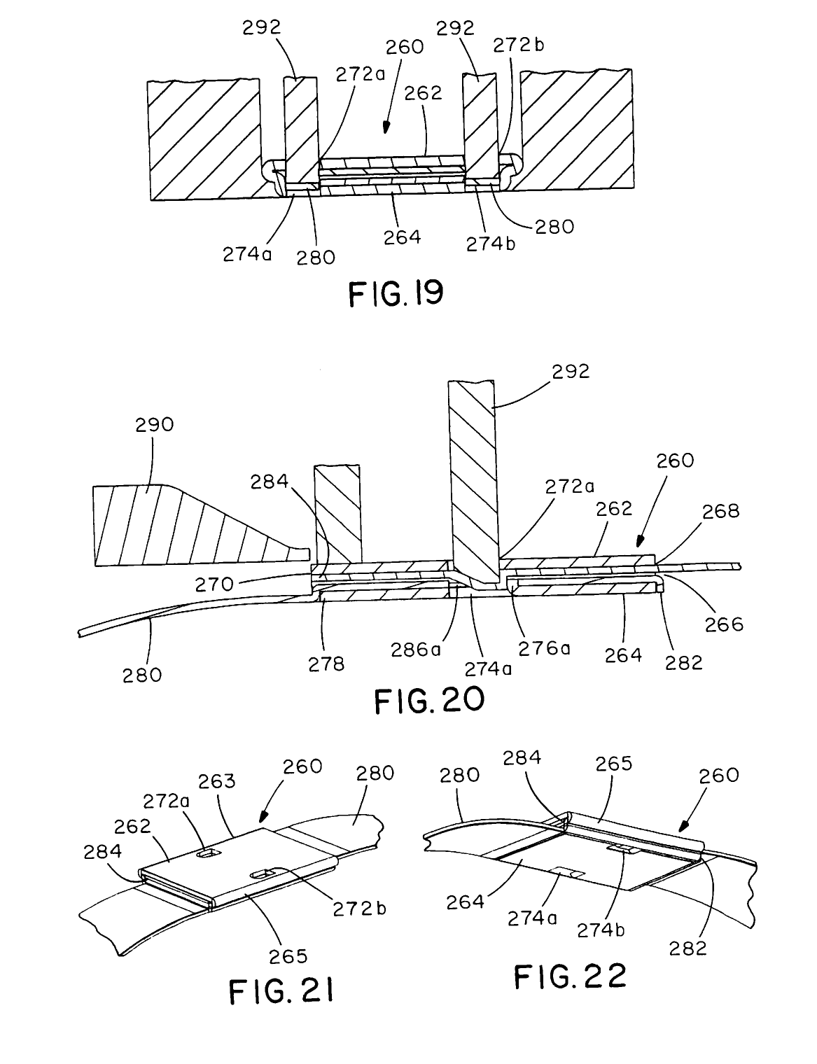

The third embodiment of the metal locking tie 250 of the present invention is illustrated in FIGS. 16-26. The third embodiment of the metal locking tie 250 includes a locking head 260 with two apertures 272a, 272b in the top wall 262 and two apertures 274a, 274b in the bottom wall 264. As illustrated in FIG. 18, the top apertures 272a, 272b are aligned with the bottom apertures 274a, 274b. The apertures 272a, 272b and 274a, 274b are located at the middle of the head 260 near the sides of the head 260. However, the apertures 272a, 272b and 274a, 274b may be located closer to the center of the head 260. The head 260 also includes two bottom tabs 276a, 276b positioned adjacent to the bottom apertures 274a, 274b in the bottom wall 264 of the head 260. Additionally, the strap 280 includes two apertures 286a, 286b. When the strap 280 is inserted through the slot 266, the apertures 286a, 286b in the strap 280 become aligned with the apertures 272a, 272b in the top wall 262 and the apertures 274a, 274b in the bottom wall 264 of the head 260.

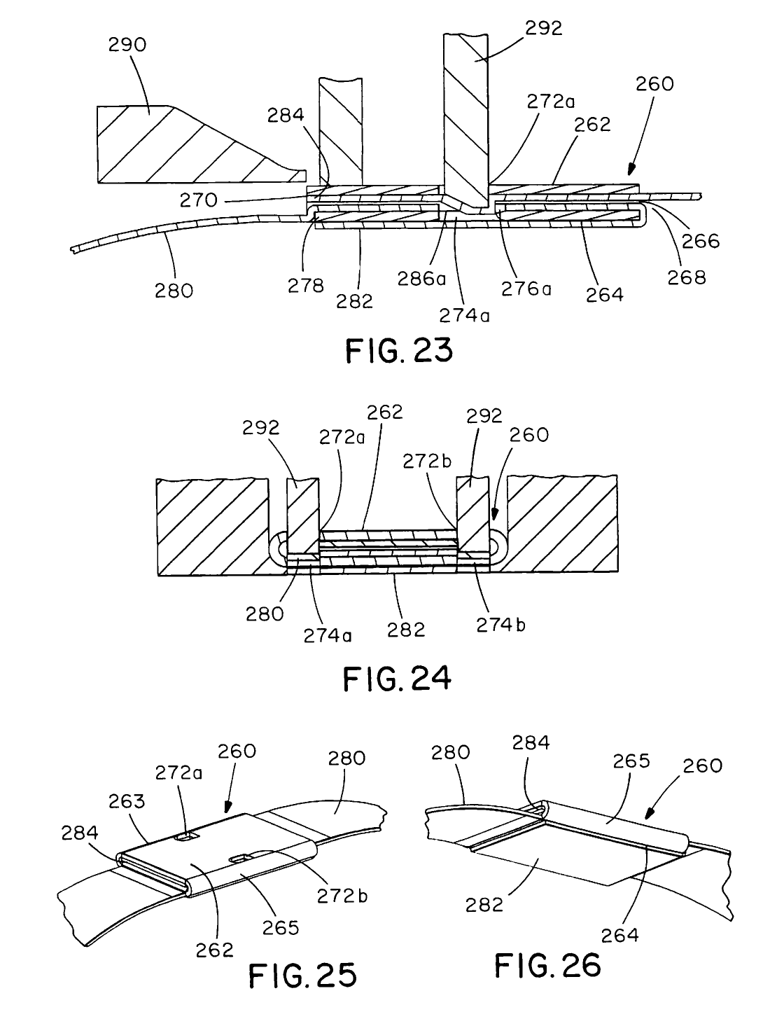

As with the second embodiment, the first end 282 of the strap 280 may engage the entrance end 268 of the slot 266 in the head 260 (FIGS. 16-22) or the strap may be positioned along the bottom wall 264 of the head 260 such that the strap 280 wraps around the entrance end 268 of the slot 266 (FIGS. 23-26).

Once the strap 280 has been wrapped around the objects to be held, the second end 284 of the strap 280 is inserted in the entrance end 268 of the slot 266 and through the slot 266. The metal locking tie tool tensions the strap 280 and the tool is activated (see FIGS. 19-20 and 23-24) to secure the strap 280 to the head 260 and to cut the strap 280.

To lock the strap 280 in the locking head 260, a locking punch 292 passes through the apertures 272a, 272b in the top wall 262 of the head 260 to engage the strap 280. The locking punch 292 presses the strap 280 to displace two portions of the strap 280 downwards through the strap apertures 286a, 286b into the apertures 274a, 274b in the bottom wall 274 in the head 260. The displaced strap portions are positioned in an area behind the bottom tabs 276a, 276b of the head 260.

As with the first and second embodiments, an edge 278 of the bottom wall 264 of the third embodiment of the head 260 is slightly offset from the top wall 262 of the head 260 to allow the cutoff blade 290 to cut the strap 280 flush with the top wall 262 of the head 260. Thus, as illustrated in FIGS. 21-22 and 25-26, the strap 280 has been cut and the second end 284 of the strap 280 is secured to the head 260.

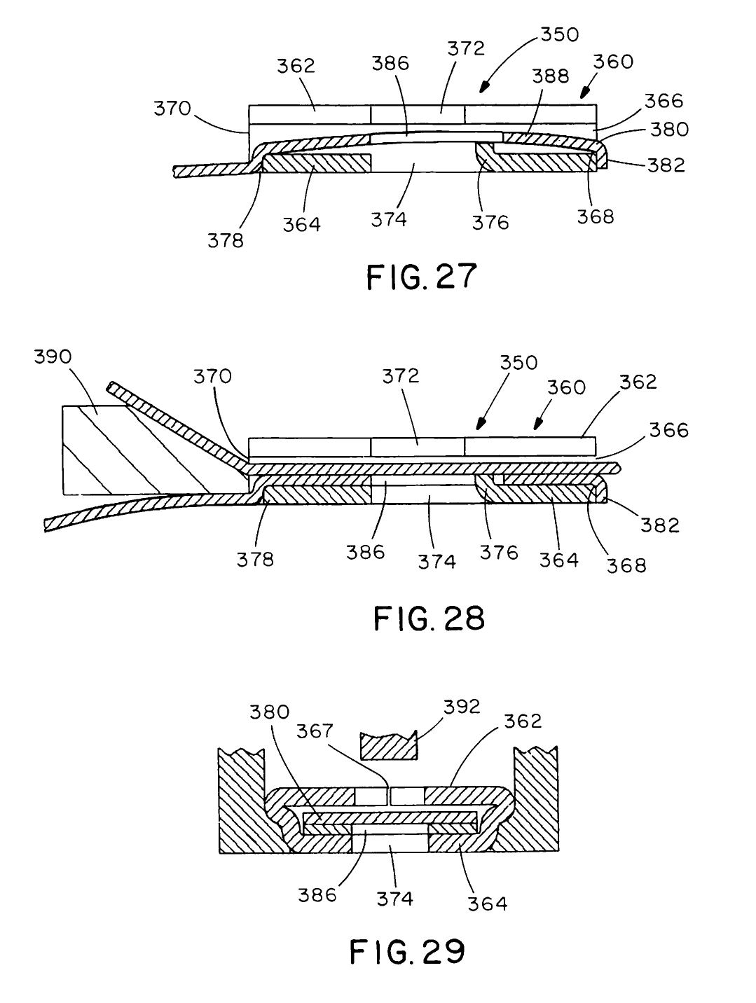

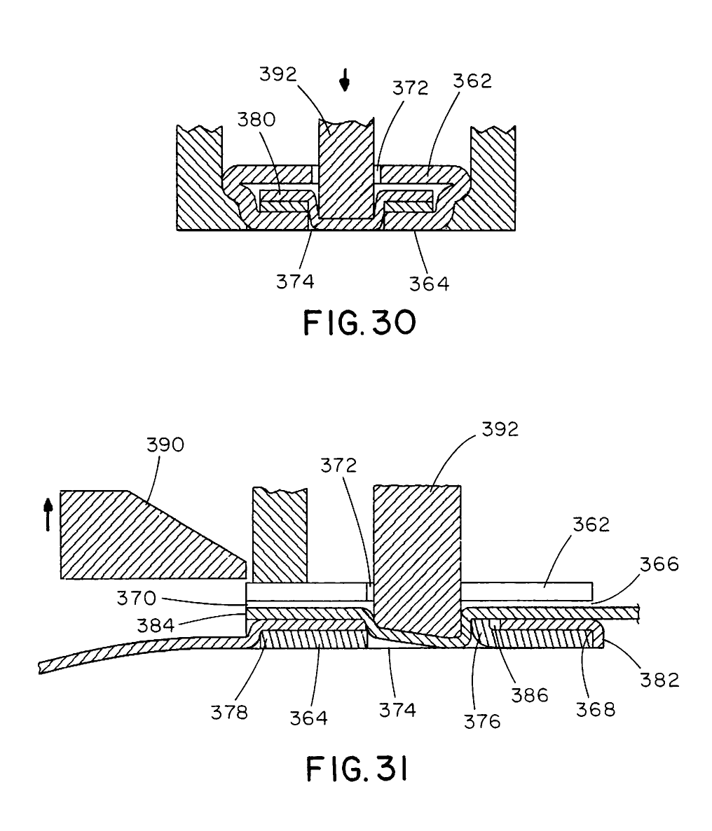

FIGS. 27-31 illustrate the metal locking tie of the present invention having a metal locking head 360 and an elongated strap 380. The metal locking head 360 includes a top wall 362 with a center aperture 372 and a bottom wall 364 with an aperture 374 and a bottom tab 376. The metal strap 380 includes a first end 382, a second end 384 and an aperture 386. The aperture 386 is located near the first end 382 of the strap. As illustrated in FIG. 27, the strap 380 is inserted in the locking head 360 such that a portion of the strap 380 is curved or bent upwards toward the top wall 362 of the metal locking head 360. Once the strap is inserted in the slot 366 the bottom tab 376 of the locking head 360 is positioned in the aperture 386 of the strap. As illustrated in FIGS. 27-28, the first end 382 of the strap is bent over to engage the entrance end 368 of the locking head 360. Once the strap has been wrapped around the objects to be held, the second end 384 of the strap is inserted in the entrance end 368 of the locking head 360. The curved or bent portion 388 of the strap creates a friction resistance with the second end 384 of the strap when the second end 384 of the strap passes through the slot 366 in the locking head 360.

FIG. 29 illustrates the locking head with a slot 367 at the center of the locking head 360. As discussed above, a metal locking tie tool tensions the strap, secures the strap to the head and cuts the strap. The locking head 360 is positioned in the metal locking tie tool so that the locking punch 392 may pass through the center aperture 372 to displace a portion of the strap 380 through the aperture 386 in the strap 380 into the aperture 374 in the bottom wall 364 of the locking head 360. As illustrated in FIG. 31, the displaced portion of the strap is positioned in an area behind the bottom tab 376.

As with the metal locking tie illustrated and discussed above, the bottom wall 364 of the locking head 360 also includes a slightly offset edge 378 to enable the cut off blade 390 to cut the strap 380 flush with the top wall 362 of the locking head 360.

As discussed above, the first end 382 of the strap 380 may also be positioned along the bottom wall 364 of the head 360 such that the strap 380 wraps around the entrance end 368 of the locking head 360 and extends through the slot 366.

Additionally, the metal locking tie illustrated in FIGS. 27-31 may also be designed with the locking head having two apertures in the top wall and two apertures in the bottom wall and the strap 380 having two apertures as illustrated in FIGS. 16-26.

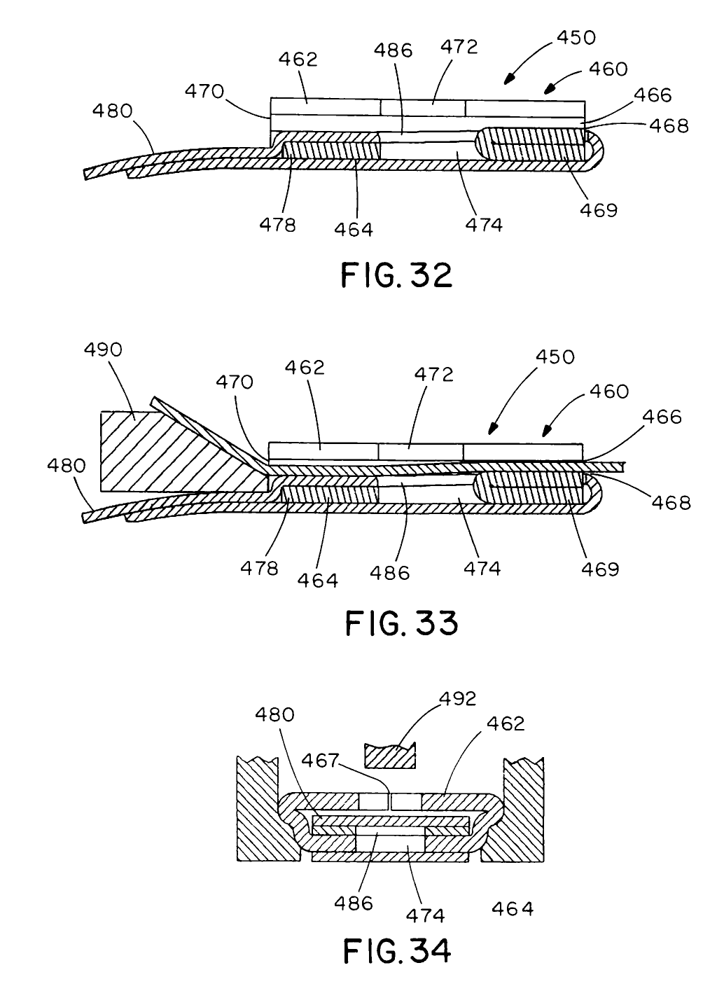

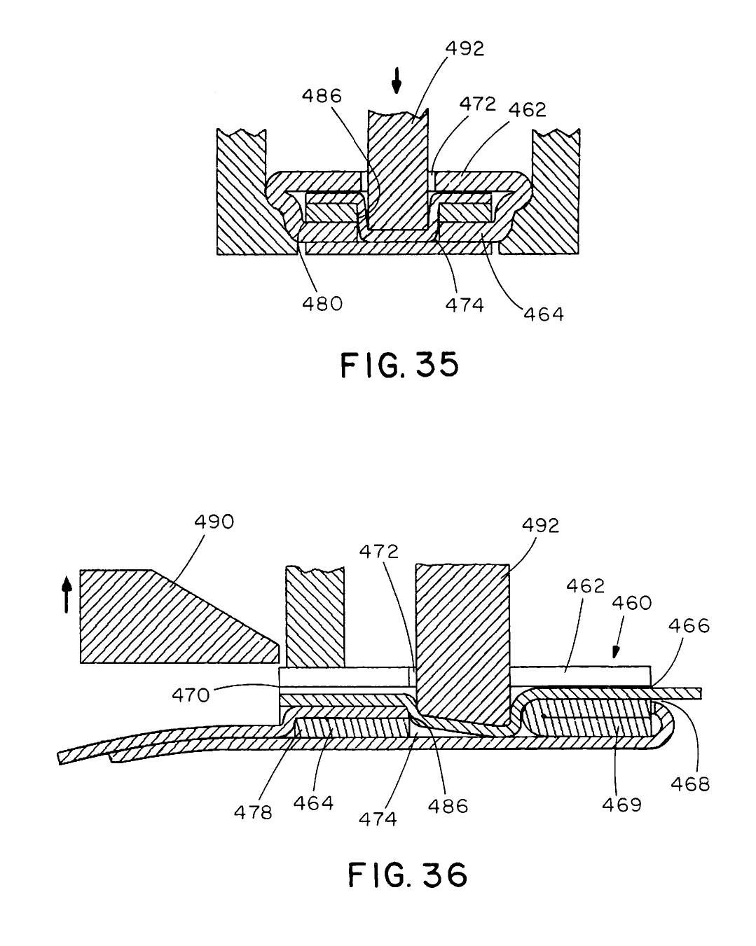

FIGS. 32-36 illustrate the metal locking tie of the present invention with a metal locking head 460 having a fold-over tab 469. The fold over tab 469 is located in the slot 466 in the locking head 460 and extends from the entrance end 482 of the locking head towards the center of the locking head 460. The fold over tab 469 reduces the opening at the entrance end 468 of the slot. When the strap 480 is inserted in the locking head 460, the fold over tab 469 engages the strap near the first end 482 of the strap. After the strap 480 is installed around a bundle of objects, the strap 480 reenters the entrance end 468 of the locking head 460. The fold over tab 469 positioned in the slot 466 creates a friction resistance with the second end 484 of the strap 480 as it passes through the slot 466 in the locking head 460.

As described above, to secure the strap to the locking head, the locking head 460 is positioned in the metal locking tie tool so that the locking punch 492 may pass through the center aperture 472 of the locking head 460. The locking punch 492 displaces a portion of the strap 480 through the aperture 486 in the strap into the aperture 474 in the bottom wall 464 of the locking head 460 thereby securing the strap 480 in the locking head 460. Once the strap is secured, the cut off blade 490 cuts the strap 480 flush with the top wall 462 of the locking head 460.

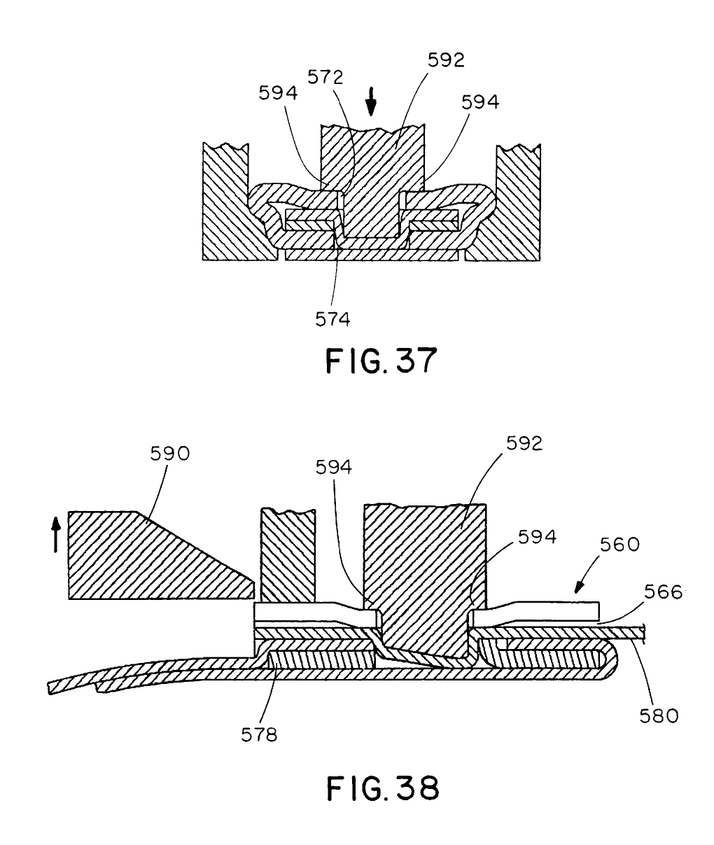

As illustrated in FIGS. 37-40, the metal locking tie tool may include a locking punch having a shoulder located on each side of the punch near the bottom of the punch. FIGS. 37-38 illustrate a locking punch 592 with shoulders 594 engaging a locking head 560 having one aperture 572 in the top wall and one aperture 574 in the bottom wall. When the metal locking tie tool is activated, the shoulders 594 of the punch 592 deform the metal locking head 560 and close the gap between the locking head 560 and the strap 580 positioned therein. The shouldered punch 592 creates a multi-directional deformation of the locking head surface thereby securing the strap in the locking head.

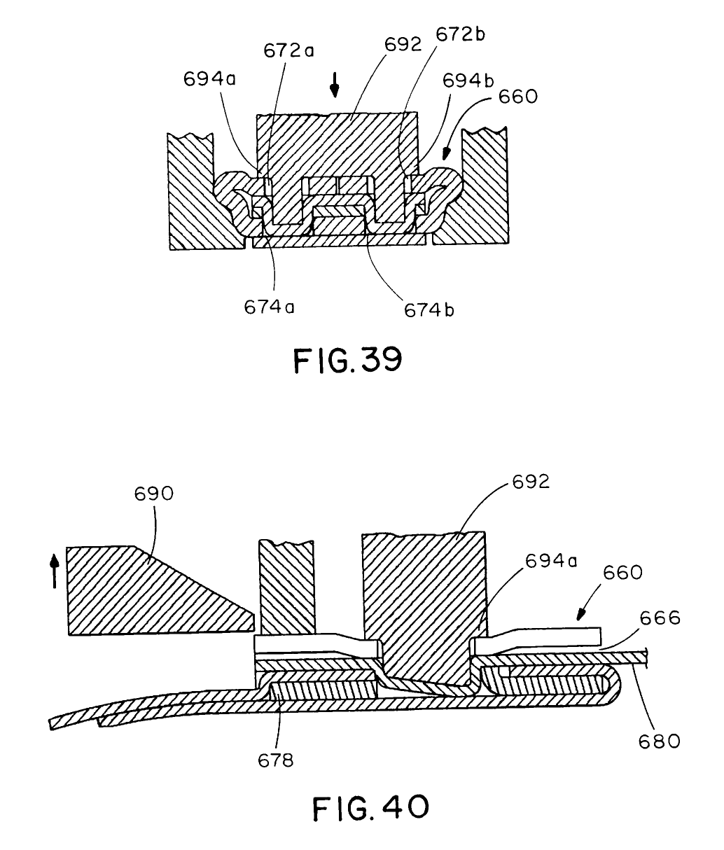

FIGS. 39-40 illustrate a locking punch 692 with shoulders 694 engaging a locking head having two apertures 672a, 672b in the top wall and two apertures 674a, 674b in the bottom wall. As with the shoulder locking punch 592 illustrated in FIGS. 37-38, the shoulders 694 of the locking punch 692 deform the locking head 660 and close the gap between the strap 680 and the locking head 660 thereby securing the strap 680 in the locking head 660.

The locking head and strap of the present invention are preferably formed of stainless steel to allow the strap to be used over a wide temperature range and to give the cable tie high strength and excellent resistance to corrosion. Additionally, as known in the art, the strap may be partially coated for increased abrasion resistance and the locking head may be heat treated for increased strength.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

What is claimed is:

1. A metal locking tie for securing a bundle of objects, the metal locking tie comprising:
a locking head, the locking head defined by a top wall, a bottom wall and sides, the locking head having a slot extending therethrough from an entrance end to an exit end, the bottom wall of the locking head having an aperture and a tab extending upwardly toward the slot in the locking head; and
a strap disposed within the locking head, the strap having a first end, a second end, and an aperture therethrough, wherein the upwardly extending tab engages the aperture in the strap when the strap is positioned in the locking head,
whereby a portion of the strap is displaced to secure the strap in the locking head.

2. The metal locking tie of claim 1, wherein the aperture in the strap is located near the first end of the strap.

3. The metal locking tie of claim 1, wherein the first end of the strap engages the entrance end of the locking head.

4. The metal locking tie of claim 1, wherein the first end of the strap wraps around locking head so that it is positioned adjacent to the bottom wall.

5. The metal locking tie of claim 1, wherein a portion of the strap is curved as the strap is inserted in the locking head.

6. The metal locking tie of claim 1, wherein the locking head further comprises a tab in the top wall, wherein the tab is downwardly displaced to engage the strap thereby displacing a portion of the strap to secure the strap in the locking head.

7. The metal locking tie of claim 1, wherein the displaced portion of the strap extends through the aperture in the strap into the aperture in the bottom wall of the locking head.

8. The metal locking tie of claim 1, wherein the locking head further comprises at least one aperture in the top wall,
whereby when a locking tool secures the strap in the locking head, the tool extends through the aperture in the top wall of the head to displace a portion of the strap thereby securing the strap in the locking head.

9. The metal locking tie of claim 8, wherein the locking head has two apertures in the top wall.

10. The metal locking tie of claim 8, wherein the displaced portion of the strap extends through the aperture in the strap into the aperture in the bottom wall of the locking head.

11. The metal locking head of claim 1, wherein the locking head further comprises a fold over tab for creating a friction resistance with the strap when the strap is inserted in the locking head.

12. The metal locking tie of claim 1, wherein the bottom wall of the locking head is offset from the top wall for enabling a locking tool to cut the strap flush with the locking head.

13. A method of securing a metal locking tie around a bundle of objects, the method comprising:
providing a locking head and a strap, the locking head having an entrance end, an exit end and a slot therethrough, the strap having a first end, a second end and an aperture therethrough;
inserting the first end of the strap in the entrance end of the locking head, through the slot in the locking head and wrapping the strap around a bundle of objects;
reinserting the strap in the entrance end of the locking head and through the slot:
displacing a portion of the strap in the locking head to secure the strap in the locking head; and
cutting the strap flush with the exit end of the locking head.

14. The method of claim 13, further comprising the step of inserting the first end of the strap with a portion of the strap curving upwards toward a top wall of the locking head.

15. The method of claim 13, wherein the locking head has at least one aperture, the aperture in the strap being aligned with the aperture in the head when positioned in the head,
whereby the displaced portion of the strap extends through the aperture in the strap.

16. The method of claim 13, further comprising the step of displacing the strap with a locking punch having at least one shoulder for deforming the locking head thereby closing any gap between the locking head and the strap.
